(19) United States
(12) Patent Application Publication
(10) Pub. No.: US 2025/0124253 A1
(43) Pub. Date: Apr. 17, 2025

(54) Memory-Efficient Execution of a Machine-Trained Model using Sparsification

(71) Applicant: Microsoft Technology Licensing, LLC, Redmond, WA (US)

(72) Inventors: Mohamed Abdelrhman Mostafa Ali EFEKI, Kirkland, WA (US); Paulo Ricardo DOS SANTOS MENDONCA, Seattle, WA (US); Benjamin Eliot LUNDELL, Seattle, WA (US); Xiaoyan HU, Redmond, WA (US)

(73) Assignee: Microsoft Technology Licensing, LLC, Redmond, WA (US)

(21) Appl. No.: 18/380,155

(22) Filed: Oct. 13, 2023

(51) Int. Cl. G06N 3/04

(52) U.S. Cl. CPC G06N 3/04

(57) ABSTRACT

A technique is described herein for receiving a selected set of weights and a mask produced by any type of sparsification process by operating on an original set of weights. The mask describes positions of the selected set of weights and a non-selected set of weights among a combined set of weights. For example, the non-selected set of weights represent weights that have been zeroed out in the original set of weights. In an inference stage, a processor directly performs computations on the selected set of weights and the mask, without the preliminary step of reconstituting the non-selected weights in memory. Instead, the processor performs computations that take into account the influence of the non-selected weights. The technique is efficient because it reduces the consumption of memory during the execution of the machine-trained model, and reduces the transactional costs associated with moving weights between memory and processing functionality.

### BACKGROUND

Many state-of-the-art machine-trained models have a relatively large number of weights. For example, large language models (LLMs) often have several billion weights. An execution system must devote a large amount of memory and processor-related resources to implement these kinds of models. These demands limit the type of computing environment that is capable of feasibly implementing these models. To address this shortcoming, an application running on a resource-constrained computing device typically interacts with a network-accessible server system which implements a large model. Such a solution is not ideal, however, as it introduces latency costs and may raise privacy-related concerns. It also requires the availability of a network connection.

The technical literature has proposed various information-reduction techniques for producing more efficient machine-trained models, including knowledge distillation, quantization, low-rank factorization, and pruning. Consider, for instance, the technique of magnitude pruning, which is a particular type of pruning. In magnitude pruning, a preliminary process zeroes out weights having the smallest absolute values. While all types of pruning improve the efficiency of a machine-trained model in some respects, the execution of even a pruned machine-trained model remains a resource-intensive task, particularly with respect to its utilization of memory.

### SUMMARY

A technique is described herein for executing a machine-trained model in a memory-efficient manner. In a preprocessing stage, any kind of sparsification process operates on an original set of weights to produce a mask and a selected set of weights. The mask identifies positions of the selected set of weights and non-selected weights within a combined set of weights. For example, a non-selected set of weights represents weights that have been zeroed out in the original set of weights. In an inference stage (during execution of the machine-trained model), a processor directly performs computations on the selected set of weights and the mask, without a preliminary step of reconstituting the non-selected weights in memory as full-length entries. Instead, the processor performs computations that take into account the influence of the non-selected weights in the combined set of weights.

The technique is efficient for a number of reasons. First, the technique reduces the storage space that is required to store the machine-trained model. Second the technique reduces the communication costs associated with transferring the machine-trained model between locations. Third, the technique reduces the consumption of memory during the execution of the machine-trained model. For instance, the technique avoids the need for representing the non-selected weights in memory as full 8 bit, 16 bit, 32 bit, or 64 bit entries, etc. Fourth, the technique reduces the transactional costs associated with moving weights between memory and processing functionality. The third and fourth advantages are especially useful in expanding the universe of devices that are capable of feasibly implementing a machine-trained model, as the consumption of memory at inference time has heretofore limited the deployment of this type of technology.

In some implementations, the selected set of weights contains half of the original weights in the original set of weights (prior to a sparsification operation).

In some implementations, each mask value in the mask is represented by a single bit. In some implementations, the combined size of the selected set of weights and the mask is about 58 percent the size of the original set of weights.

In some implementations, a particular mask value in the mask identifies whether a particular pair of neighboring weights in the combined set of weights includes a selected weight as a first member or a second member.

This Summary is provided to introduce a selection of concepts in a simplified form: these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows an illustrative processing environment for developing and running a machine-trained model (“model”).

FIG. 2 shows an example of the operation of the processing environment of FIG. 1.

FIG. 3 is a continuation of the example of FIG. 2.

FIG. 4 shows one implementation of a processing unit and memory of an execution system of FIG. 1.

FIG. 5 show two illustrative sparsification patterns that can be applied by a sparsification system of FIG. 1.

FIG. 6 shows a variation to the processing environment of FIG. 1, in which a mask is incorporated into a selected set of weights.

FIG. 7 shows an illustrative language model, which is one type of model to which the processing environment of FIG. 1 can be applied.

FIG. 8 is a flowchart that shows one manner of operation of the processing environment of FIG. 1.

FIG. 9 is a flowchart that shows preprocessing operations that precede the operations of the process of FIG. 8.

FIG. 10 shows computing equipment that, in some implementations, is used to implement the processing environment of FIG. 1.

FIG. 11 shows an illustrative type of computing system that, in some implementations, is used to implement any aspect of the features shown in the foregoing drawings.

The same numbers are used throughout the disclosure and figures to reference like components and features.

### DETAILED DESCRIPTION

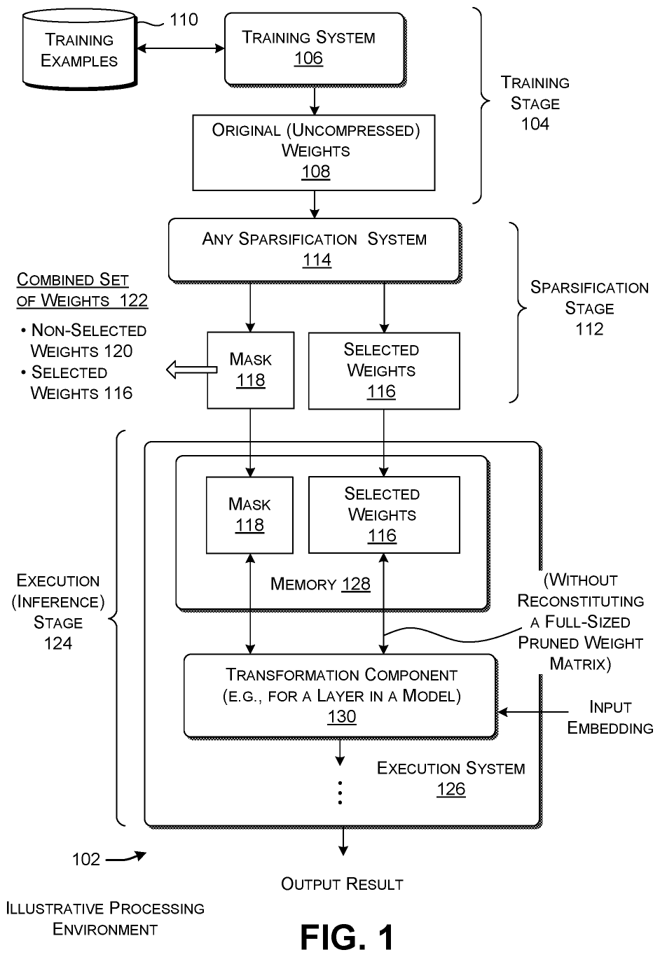

FIG. 1 shows a processing environment 102 for developing and running a machine-trained model (“model”). In a training stage 104, a training system 106 produces an original set of uncompressed weights 108 based on training examples in a data store 110. In a sparsification stage 112, a sparsification system 114 operates on the original set of weights 108 to produce a selected set weights 116 and a mask 118. “Sparsification” and its variants refer to an operation of making something sparser. The mask 118 identifies positions of the selected set of weights 116 and a non-selected set of weights 120 among a combined set of weights 122. The selected set of weights 116 are weights that are selected to play a subsequent role in an inference stage of processing. The non-selected set of weights 120 are weights that are effectively ignored in the inference stage of processing. An “original weight” or value is an entry in the original set of weights 108. A “selected weight” or value is an entry in the selected set of weights 116. A “non-selected weight” or value is an entry in the non-selected set of weights 120.

In some implementations, the non-selected set of weights 120 are weights in the original set of weights 108 that have been set to zero or are represented by any information (e.g., integers, markers, or flags) that represent the numerical value of zero. More generally, a non-selected weight is any weight that the inference stage is configured to interpret as a weight that can effectively be ignored. In some implementations, the selected set of weights 116 are mostly (or all) non-zero values, but this is not necessarily so. That is, some of the selected set of weights 116 can also be zero.

In some implementations, the combined set of weights 122 (which is made up of the selected set of weights 116 and the non-selected set of weights 120) is the same size as the original set of weights 108. In some implementations, the weights in the combined set of weights 122 can be considered counterparts to original weights with the same positions in the original set of weights 108. However, there is no expectation that a selected weight in the selected set of weights 116 and a counterpart original weight in the original set of weights 108 will have the same values; indeed, in most cases, they will not have the same values. Note that the mask 118 produced by the sparsification system 112 implicitly identifies the combined set of weights 112, but the sparsification system 114 need not produce an actual output result that that corresponds to the combined set of weights 122.

In an execution stage 124, also referred to as the inference stage, an execution system 126 executes the machine-trained model based on the selected set of weights 116 and the mask 118. More specifically, a memory 128 stores the selected set of weights 116 and the mask 118. A transformation component 130 directly operates on the selected set of weights 116 and the mask values in the mask 118 in “desiccated form,” e.g., without first reconstituting the zero values of the combined set of weights 122 in memory 128. Instead, the transformation component 130 uses the mask values to computationally reproduce the influence of the zero values in the combined set of weights 122.

In some implementations, the sparsification system 114 independently produces a mask and a selected set of weights for each layer of the model. The execution system 126 applies the selected sets of weights and the masks to appropriate layers of the model. To facilitate explanation, however, the functions of the processing environment 102 will be described below with respect to a representative selected set of weights and a representative mask that are applicable to a particular layer of the model.

The processing environment 102 has at least the following technical advantages. First, the processing environment 102 reduces the storage space that is required to the store the model. Second the processing environment 102 reduces the communication costs associated with transferring the model between locations, e.g. by downloading the model from a server system (not shown) to a local computing device (not shown). Third, the processing environment 102 reduces the consumption of the memory 128 during the execution of the model. For instance, the processing environment 102 avoids the need for representing the non-selected weights (e.g., the zero values) in the combined set of weights 122 in the memory 128 as full 8 bit, 16 bit, 32 bit, or 64 bit entries, etc. Fourth, the processing environment 102 reduces the transactional costs associated with moving weights between the memory 128 and the transformation component 130. All of these characteristics also enable a computing device having limited resources to download, store, and run the model. For instance, the characteristics enable some user computing devices to run the model without access to a server system and/or with reduced access to the server system.

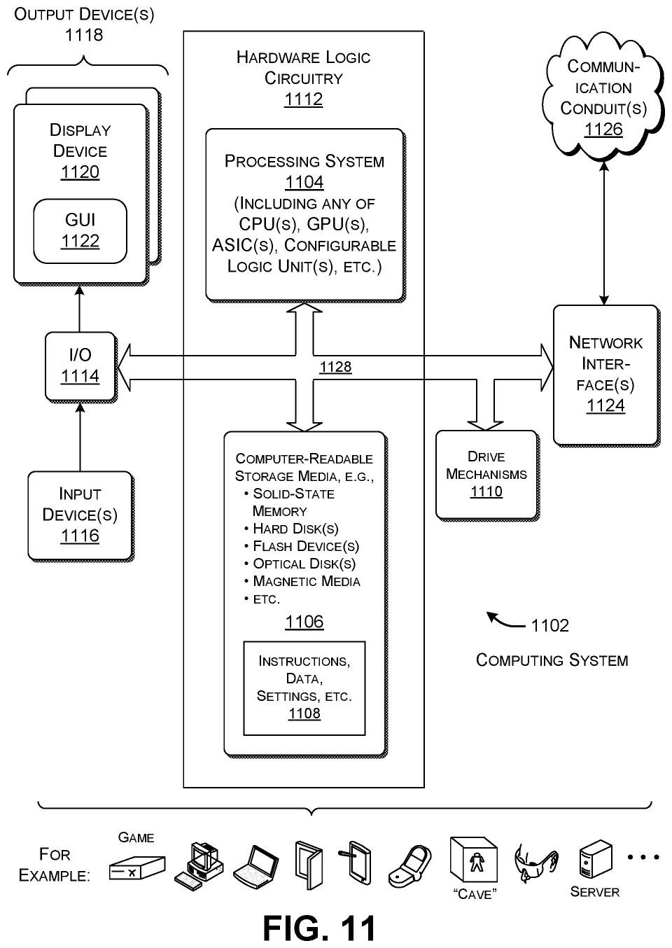

The above-described functions and advantages will be described in greater detail below. The following terminology will be used in describing some examples. A “machine-trained model” or “model” refers to computer-implemented logic for executing a task using machine-trained weights that are produced in a training operation. A “weight” (or synonymously, a “weight value”) refers to any type of parameter value that is iteratively produced by the training operation. A “token” refers to a unit of information processed by the model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. An “embedding” is a distributed vector that represents an information item in a vector space. A “distributed vector,” in turn, expresses the semantic content of an information item by distributing information over its k dimensions. A distributed vector is in contrast to a sparse one-hot vector that allocates particular dimensions of the vector to particular concepts. In some contexts, terms such as “component,” “module,” “engine,” and “tool” refer to parts of computer-based technology that perform respective functions. FIGS. 10 and 11, described below, provide examples of illustrative computing equipment for performing these functions.

Note that, in most examples below, the mask 118 is said to represent the locations of the selected set of weights 116 in the combined set of weights 122. Note that any expression of the location of the selected weights 116 also implicitly describes the locations of the non-selected weights 120 produced by the sparsification system 114. In other implementations, the mask 118 directly specifies the locations of the non-selected weights 120. Any general reference to specifying the locations of the selected weights 116 should be interpreted equivalent to specifying the locations of the non-selected weights 120, and vice versa.

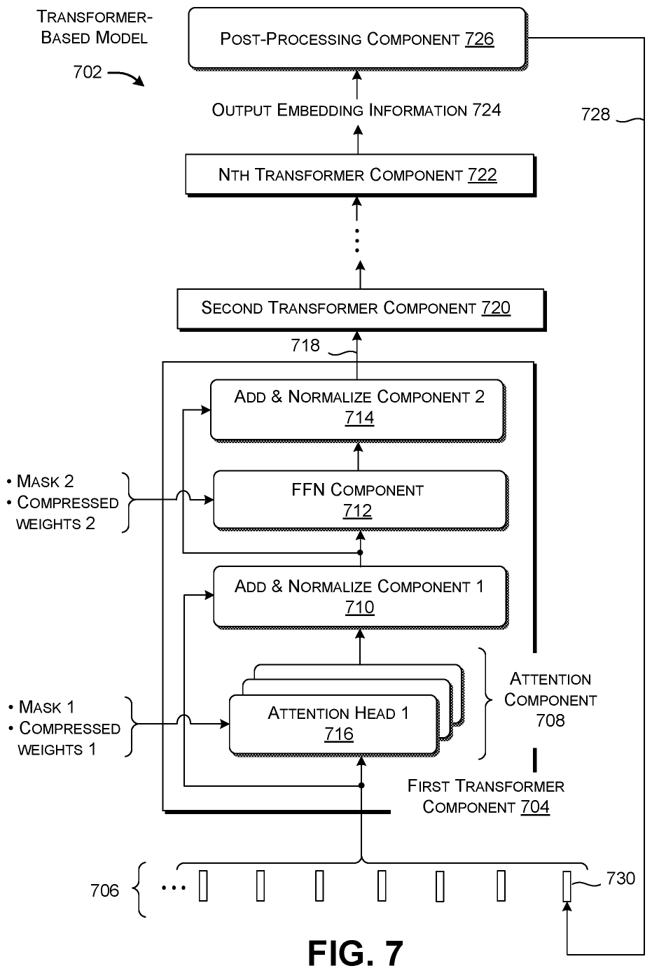

In some implementations, the model processed by the processing environment 102 is a language model. Further details regarding one implementation of a transformer-based language model is provided below in connection with the explanation of FIG. 7. More generally, the processing environment 102 is capable of operating on any type of machine-trained model, including any of a convolutional neural network (CNN), a recurrent neural network (RNN), a stable diffusion model, etc.

In some implementations, the training system 106 uses any environment-specific approach to iteratively generate the original set of weights 108. For instance, assume that the training examples in the data store 110 provide linguistic items (e.g., text passages) and associated ground-truth results (e.g., classifications or predicted next words). In an illustrative forward and backward pass, the training system 106 uses the model being trained to transform a batch of the linguistic items into model-generated output results. The training system 106 then applies any type of training objective (e.g., cross entropy) to compute loss information based on the differences between the model-generated output results and the ground-truth results. The training system 106 updates the weights of the model based on the loss information, e.g., using gradient descent in combination with back propagation. The training system 106 represents the original set of weights in various environment-specific ways, e.g., as floating point numbers of predetermined size (8 bits, 16 bits, 32 bits, or 64 bits, etc.).

In some examples, the training performed by the training system 106 constitutes fine-tuning a pre-trained model. One example of a publicly-available pre-trained language model is described in Touvron, et al., “LLaMA: Open and Efficient Foundation Language Models,” arXiv, arXiv:2302.13971v1 [cs. CL], Feb. 27, 2023, 27 pages. Another example of a publicly-available pre-trained model language model is the BLOOM model described in Scao, et al., “BLOOM: A 176B-Parameter Open-Access Multilingual Language Model,” arXiv, arXiv:2211.05100v2 [cs.CL], Dec. 11, 2022, 62 pages. Background on the general task of pre-training generative language models is described in Radford, et al., “Improving Language Understanding by Generative Pre-training,” OpenAI, San Francisco California, Jun. 11, 2018, 12 pages. In other examples, the original set of weights 108 represents a pre-trained model itself, without fine-tuning.

The sparsification system 114 can apply any sparsification process that is capable of: a) setting a prescribed number of weights in the original set of weights 108 to the set of non-selected weights 120; and b) selecting the locations of the non-selected weights 120 (and the selected weights 116) in the combined set of weights 122 according to a reproducible pattern which is capable of being described by the mask 118. For instance, as will be described in below in detail, the sparsification system 114 uses a 1:2 sparsifying ratio to set one weight to a non-selected weight in a neighboring pair of two weights in the original set of weights 108. Another pattern specifies a 2:4 sparsifying ratio, which sets two weights to non-selected weights in a group of four neighboring weights in the original set of weights 108, and so on. As will be illustrated below, the number of bits that are required to describe a sparsification pattern increases with the complexity of the sparsification pattern. Other than the above expectations, the processing environment 102 can be said to be agnostic to the particular type of sparsification algorithm applied by the sparsification system 114.

In some implementations, the sparsification system 114 identifies the combined set of weights 122 based on the following objective:

$$arg {min}_{mask {M}_{ℓ} {\hat{W}}_{ℓ}} {‖ {W}_{ℓ} {X}_{ℓ} - ( {M}_{ℓ} ⊙ {\hat{W}}_{ℓ} ) {X}_{ℓ} ‖}_{2}^{2} . \qquad ( 1 )$$

In this equation, [symbol] refers to the mask 118 that specifies the locations of the selected set of weights 116 and the non-selected set of weights 120 in the combined set of weights 122. [symbol] refers to the weights in the original set of weights 108 being trained (prior to sparsification). [symbol] refers to the selected set of weights 116 that remain in the combined set of weights 122. [symbol] refers to the features of the training examples on which training is performed. [symbol] or DNN( [symbol] ) refers to original output results produced by the model based on the original set of weights 108, where DNN represents the processing performed by a deep neural network. [symbol] or DNN( [symbol] ) refers to sparsified-weight output results produced by the model based on combined set of weights 122. Overall, Equation (1) seeks to adjust the mask 118 and the weights [symbol] in the selected set of weights 116 such that the performance of the model is not significantly degraded as a result of the sparsification operation. It does this based on the L2 difference between the original output results and the sparsified-weight output results. In some implementations, this objective is achieved by first fixing the mask 118 and then adjusting the weights [symbol] of the selected set of weights 116.

In some examples, at least some aspects of the sparsification system 114 are implemented using the SparseGPT code that is publicly posted by Frantar, et al. of ISTA on the GitHub website on Jul. 20, 2023. (ISTA refers to the Institute of Science and Technology Austria, Distributed Algorithms and Systems Lab, of Klosterneuburg, Austria.) The SparseGPT algorithm is also described in Frantar, et al., “SparseGPT: Massive Language Models Can Be Accurately Pruned in One-Shot,” arXiv, arXiv: 2301.00774v3 [cs.LG], Mar. 22, 2023, 14 pages. In another implementation, the sparsification system 114 uses, at least in part, magnitude pruning to identify the combined set of weights 122. For example, the sparsification system 114 identifies a prescribed number of weights in a group of neighboring weights in the original set of weights 108 that have the smallest absolute values. The sparsification system 114 then sets these values to zero, while ensuring that a predetermined pruning pattern is satisfied. For the 1:2 pruning ratio, for example, the sparsification system 114 ensures that every pair of neighboring weights has one weight that is set to zero by the sparsification system 114, and one weight that is not set to zero by the sparsification system 114.

Note, however, that the sparsification system 114 can use any technique for thinning the original set of weights 108, not limited to pruning, including knowledge distillation techniques. Further, although FIG. 1 shows the training and sparsification as separate processes, FIG. 1 is intended to encompass the case in which the training system 106 encompasses the sparsification system 114, and the result of the training process is the selected set of weights 116 and the mask 118.

In some implementations, the execution system 126 represents any type of processing hardware, such as one or more central processing units (CPUs) and/or one or more specialized processing units (including graphics processing units (GPUs), neural processing units (NPUs), etc.). FIG. 11 shows further details regarding one implementation of hardware for implementing the execution system 126.

The transformation component 130 represents logic for mapping an input embedding v to an output result (such as an output embedding) based on the selected set of weights 116 and the mask 118. For example, the transformation component 130 represents the functions associated with a single layer of a neural network. Although not shown, the execution system 126 can apply a pipeline of such transformation components. The final transformation component provides a final output result, such as an output embedding or scalar classification result.

More specifically, assume that the transformation component 130 is a first transformation component in a pipeline of transformation components (not shown). Here, the input embedding v represents an input submission of any kind, such as an input query submitted by a user. Alternatively, assume that the transformation component represents an intermediary transformation component in a pipeline of transformation components. Here, the input embedding represents an output embedding produced by a preceding transformation component in the pipeline (not shown), and the output embedding represents the output of the intermediary component. The final output result produced by the final transformation component produces a response to the submission, such as an answer to a user's query.

In some examples, a developer or end user can obtain a model by downloading the selected set of weights 116 and the mask 118 from a network-accessible repository of models (not shown). In this scenario, the processing environment 102 reduces the amount of information that needs to be transferred, compared to the case in which the original set of weights 108. In other examples, a developer or end user obtains the original set of weights 108. A local sparsification system 114 then operates on this information to produce the selected set of weights 116 and the mask 118.

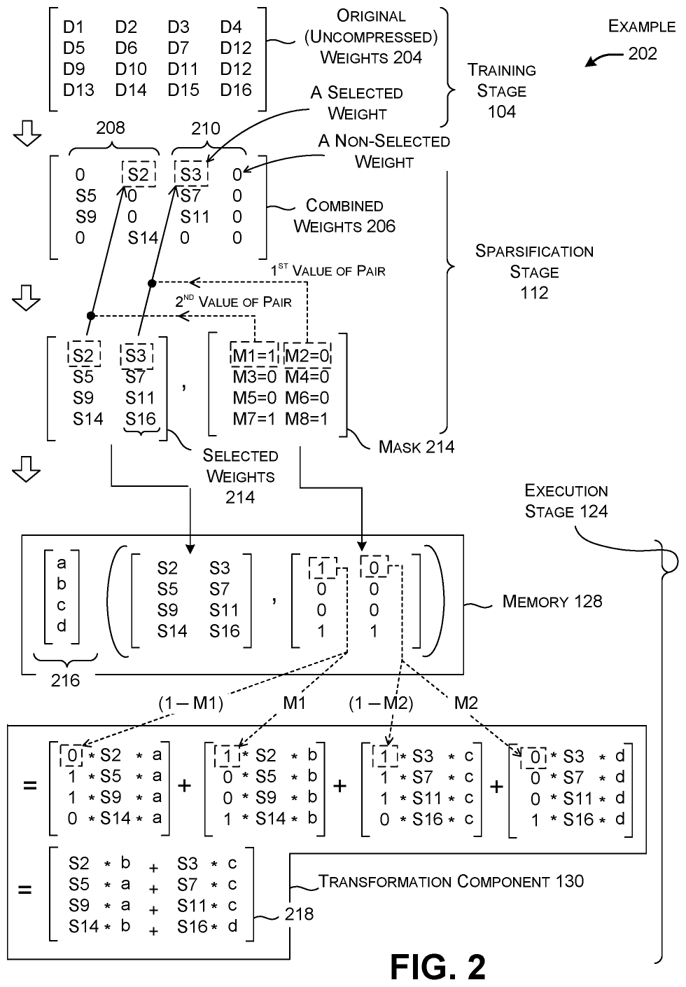

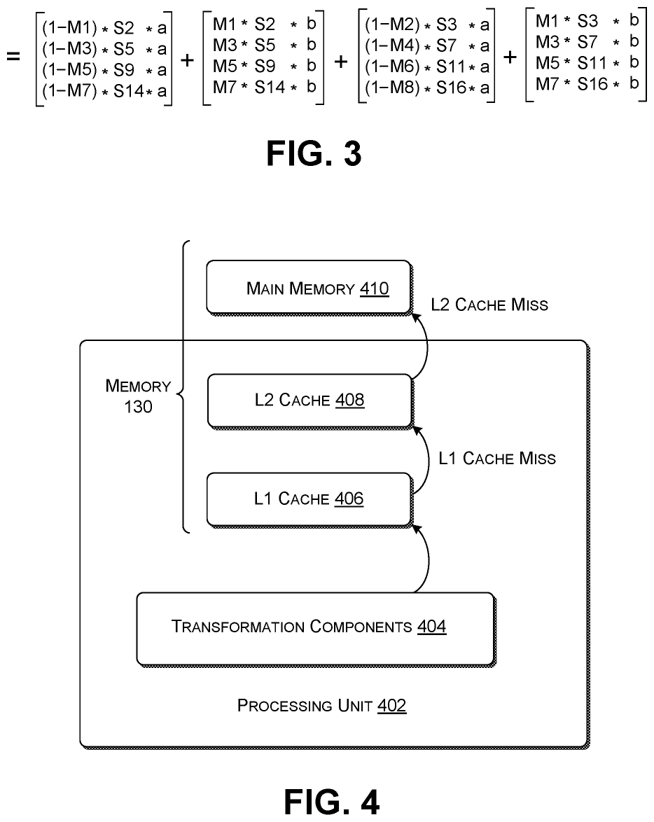

FIG. 2 shows a simplified example 202 of the operation of the processing environment 102 of FIG. 1. In the training stage 104, assume that the training system 106 produces an original set of weights 204, which may only correspond to a subset of a much larger set of original weights (not shown). The original set of weights 204 are arranged in a 4 by 4 matrix of sixteen weights (D1, D2, . . . , D16), most or all of which are non-zero.

Assume that the sparsification system 114 sets a prescribed subset of the original set of original weights to non-selected weights. This yields a combined set of weights 206, which may only be a subset of a much larger set of weights (not shown). In this particular case, the sparsification system 114 chooses non-selected weights in such a manner that each neighboring pair of weights includes a non-selected weight and a selected weight. For example, a first pair 208 of weights includes a first member which is set to a non-selected weight (here, zero), and a second member which is a selected weight (S2). A second pair 210 of weights includes a first member which is a selected weight (S3) and a second member which is set to a non-selected weight (here, zero). This pattern corresponds to a 1:2 sparsification ratio.

Note that the sparsification system 114 uses a rule that constrains what element of the combined set of weights 122 is set to a non-selected weight, but does not a priori specify the precise placement of the non-selected weight. For instance, for a 1:2 sparsification ratio, the sparsification system 114 requires one of a pair of neighboring weights to be set to a non-selected weight, but does not specify which one of these weights should be set to the non-selected weight. In this sense, the sparsification system 114 can be said to apply a semi-structured sparsification strategy.

As an output result, the sparsification system 114 produces a selected set of weights 212 and a mask 214. Assume that S represents the selected set of weights, and Sn represent an element in the selected set of weights (where n is an index value). The sparsification system 114 produces the mask 214 by providing mask values that describe the locations of the selected weights in the combined set of weights 206. Assume that M denotes the mask, and Mk represent the mask values in the mask (where k is an index value). For example, a mask value M1 is set to 1 to indicate that the second member of the pair 208 is a selected weight. A mask value M2 is set to 0 to indicate that the first member of the pair 210 is a selected weight.

Assume that the execution system 126 receives an input embedding 216 that is expressed as a vector v having four values (a, b, c, and d). The memory 128 stores the input embedding 216, the selected set of weights 212, and the mask 214. At no point does the execution system 126 reconstitute the full combined set of weights 206 in the memory 128 based on the selected set of weights 212 and the mask 214.

In this illustrative example, the transformation component 130 performs a matrix multiplication operation by multiplying the input embedding 216 by the selected set of weights 212, subject to the mask values in the mask 214. In this process, the transformation component 130 forms the dot product: ((1−M)⊙S)@v_{odd}+(M⊙S)@vₑᵥₑₙ. The first term in this dot product represent elementwise multiplication of (1−M) by the selected set of weights 212 (in which elementwise multiplication is represented by the symbol ⊙), multiplied (via standard matrix multiplication as represented by the symbol @) by the odd elements of the input embedding 216 (here elements a and c). For the particular example of FIG. 2 in which binary mask encoding is used, 1−M represents the binary opposite of M, in the sense that when a particular mask value is 0, 1−M is 1, and vice versa. The second term in the dot product represents elementwise multiplication of M by the selected set of weights 212, multiplied (via standard matrix multiplication) by the even elements of the input embedding 216 (here elements b and d). FIG. 4 shows an expansion of the computations performed by the transformation component 130 in executing the above equation.

More specifically, as shown in FIG. 2, the transformation component 130 multiplies the first element (S2) of the selected set of weights 212 by both (1−M1) (in the first column) and M1 (in the second column). The transformation component 130 multiplies the second element (S3) of the selected set of weights by both (1−M1) (in the third column) and M2 (in the fourth column), and so on. By doing so, the transformation component 130 computationally reconstitutes the removed non-selected weights from the combined set of weights 206, without actually reconstituting the non-selected weights as full-length entries in the memory 128. An end result 218 of the computations performed by the transformation component 130 is the same result that would be obtained by multiplying the input embedding 216 by the combined set of weights 206.

For a 1:2 sparsification ratio, the selected set of weights 212 is 50 percent the size of the combined set of weights 206. The mask 214 adds some overhead to the size of the selected set of weights 212, but not a large amount. For example, in some examples, the combined size of the selected set of weights 212 and the mask 214 is about 58 percent the size of the combined set of weights 206. These characteristics enable the processing environment 102 to efficiently download and store the model. Further, these characteristic improve the performance of the execution system 126 for two reasons. First, the execution system 126 does not need to allocate memory for storing the non-selected weights, which would otherwise be represented (for example) as 8 bit, 16 bit, 32 bit, or 64 bit, etc. entries. Second, the execution system 126 foregoes the resource-intensive task of moving these non-selected weights between the memory 128 and the transformation component 130.

Viewed from another perspective, the program instruction accounts for two possibilities when it applies each mask value to a particular weight from the selected set of weights 212, one of which will inherently resolve to zero during the execution of the instruction (depending on whether the mask value is 1 or 0), and one of which will resolve to a non-zero result (if in fact the particular weight of the selected set of weights 212 is itself non-zero). The transformation component 130 can therefore be said to use each mask value to control a branching decision. In other words, the transformation component 130 uses a particular mask value of the mask to evaluate plural ways of applying a particular weight from the selected set of weights to the input embedding 216, all but one of which will resolve to zero.

Consider, for example, the application of the mask value M1 to the weight S2, and the application of the mask value M2 to the weight S3. The execution of the program instruction results in the weight S2 being applied to the second element b of the input embedding 216 (because the application of the weight S2 to the element a is effectively zeroed out). The execution of the program instructions results in the weight S3 being applied to the third element c of the input embedding 216 (because the application of the weight S3 to the element d is zeroed out).

FIG. 4 is a more detailed depiction of one implementation of a processing unit 402 of the execution system 126 of FIG. 1. For example, the processing unit 402 represents a GPU or an NPU or any other type of general-purpose or specialized processing device. Although not shown, the execution system 126 can include two or more of these types of processing units.

Transformation components 404 represent the logic associated with the layers of a multi-layer neural network. In performing its computations, a transformation component interacts with an L1 cache 406. Upon an L1 cache miss (meaning that a requested data item is not stored in the L1 cache 406), the transformation component obtains the data item from an L2 cache 408. Upon an L2 cache miss (meaning that a requested data item is not stored in the L2 cache 408), the transformation component obtains the data item from a main (system) memory 410. Together, the L1 cache 406, L2 cache 408, and main memory 410 constitute the memory 128 shown in FIG. 1. The access time required to access an information item from memory is ranked as follows: the L1 cache 406 (fastest), the L2 cache 408 (next fastest), and the main memory 410 (slowest).

In addition to making efficient use of the memory 128, the sparsification strategy shown in FIGS. 1 and 2 reduces the number of memory access transactions performed by the transformation components 404. This is because the transformation components 404 only needs to access the selected set of weights 116, not the non-selected weights 120 in the combined set of weights 122. It is true that the transformations components 404 are required to access the mask 118. But, in some examples, each mask value in the mask 118 contains only a single bit information (0 or 1), and therefore the task of accessing the mask 118 does not add significant transactional cost to the operation of the transformation components 404.

More specifically, in some examples, the L1 cache miss rate is about 1.73 times larger for an uncompressed set of weights compared to the selected set of weights 212, with respect to a LLaMA-based language model having 7 billion weights (in unsparsified form). That is, each transformer component in the LLaMA-7B model has about 75M weights. In uncompressed form, each transformer component requires, at 16-bit float precision, about 150 MB of memory. When compressed, each transformer component will use instead about 87 MB of memory. For a first round of L1-caching (assuming an L1 cache size of 128 KB), the uncompressed model will have about 1172 cache misses compared to about 680 cache misses for the compressed version. 1172 cache misses is about 1.73 larger than 680 cache misses.

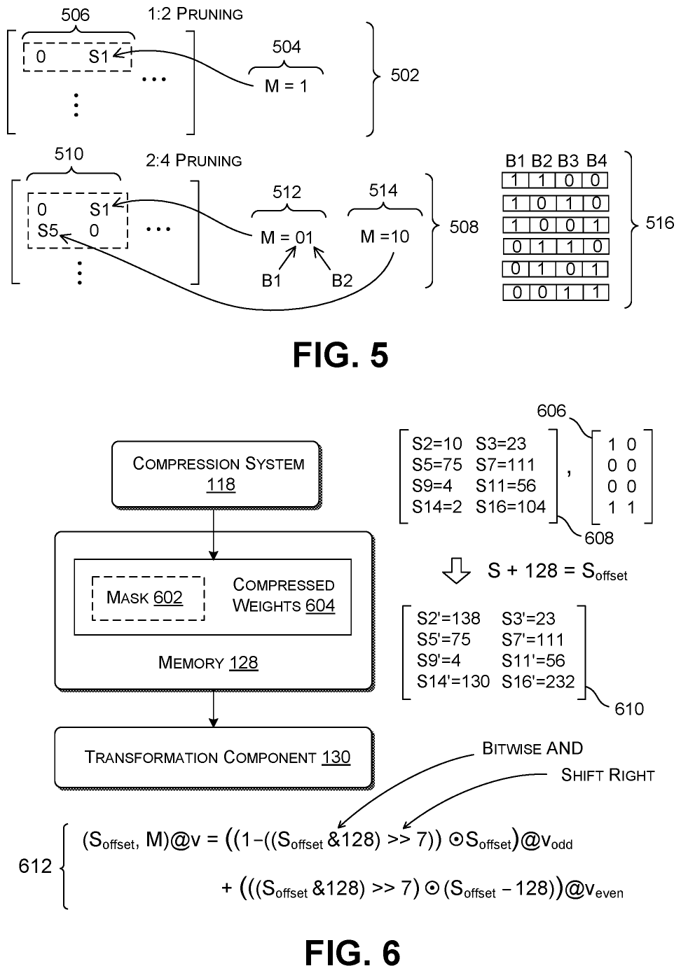

FIG. 5 serves as a vehicle for demonstrating that the processing environment 102 is applicable to different sparsification patterns. In a first case 502, the processing environment 102 applies a 1:2 sparsification ratio, as previously described. Here, a particular mask value 504 specifies which element of a pair of weights 506 is a selected weight. The particular mask value 504 is 1, which indicates that the second element (S2) of the pair of weights 506 is a selected weight. The mask value 504 can also be said to implicitly specify that the first member of the pair of weights 506 is a non-selected weight. The particular mask value 504 can be expressed as a single bit (that is, having a value of either 0 or 1).

In a second case 508, the processing environment 102 applies a 2:4 sparsification ratio, in which there are two selected weights in a group 510 of four elements. There are six different combinations of the placement of these two selected weights. In the example shown in FIG. 5, a particular mask value 512 specifies a binary value of 01, indicating that a first of the two selected weights (S1) in the group 510 occurs in a second position of the group 510. A particular mask value 514 specifies a binary value of 10, indicating that a second of the two selected weights (S5) occurs in a third position of the group 510.

Although not shown, the transformation component 130 for the second case 508 can reconstruct the combined set of weights 122 by selectively multiplying each selected weight in the selected set of weights 116 by different combinations of a first bit (B1) and a second bit (B2) of a particular two-bit mask value. For example, (1−B1)*(1−B2) will equal 1 for only a mask value of 00, (1−B1)*B2 will equal 1 for only a mask value of 01, B1*(1−B2) will equal 1 for only a mask value of 10, and B1*B2 will equal 1 only for a mask value of 11. This is just one example: other implementations can use other strategies for reconstructing the combined set of weights 122. In another implementation, for example, the six possibilities 516 of the 2:4 sparsification ratio are represented with 3 bits (B1, B2, B3). That is, the first three elements of the four-element pattern are represented by bits B1, B2, and B3, respectively, while a fourth element is represented by a fourth bit B4 which is a combination of the first three bits, e.g., B4=2−B1−B2−B3. In some implementations, the two selected weights are multiplied by appropriate combinations of these bits to place the selected weights in the correct position within the 2:4 sparsity pattern. For example, the first bit B1 will equal 1 only if the first of the two selected weights occurs as the first element in the pattern. The value (1−B1)*B2 is 1 only if the first of the two selected weights occurs as the second element of the pattern, and so on.

As can be appreciated, the size of the mask values increase as the sparsification pattern becomes more complex. Similarly, the complexity of the computational reconstruction performed by the transformation component 130 increases as the sparsification pattern becomes more complex. Thus, the efficiency of the processing environment 102 can be said to diminish as the sparsification pattern becomes more complex.

FIG. 6 shows another variation of the examples set forth above. In this case, the sparsification system 114 embeds a mask 602 into a selected set of weights 604. The transformation component 130 computationally reconstructs mask values based on the selected set of weights 604. This is beneficial because it eliminates the overhead associated with storing and loading a separate mask. The process of extracting mask values adds some computational overhead. In most cases, however, the savings that is gained by eliminating the mask is larger than any price associated with added computational complexity. More generally, the range of computing platforms that can successfully implement a model is most often constrained by memory limitations, not processor-related limitations. Additional computations can introduce additional FLOPs into the operation of the transformation component 130, but a memory access transaction can consume 10 processor cycles or more.

In one implementation, the sparsification system 114 specifically adds the value 128 (having a binary expression of 10000000) to each weight of the selected set of weights for which the mask value is 1: otherwise, the sparsification system 114 leaves the weight unmodified. For example, assume that a first value of a mask 606 is 1: in response, the sparsification system 114 adds a value of 128 to a first element of an original selected set of weights 608 (to produce a value of S2′=10+128=138). Assume that a second value of the mask 606 is 0; in response, the sparsification system 114 does not modify a second element of the original selected set of weights 608 (to yield an unmodified value of S3′=23). A selected set of weights 610 represents the complete set of modified weights.

In one approach, the transformation component 130 computationally extracts a mask value by performing a bitwise AND operation (represented in a program instruction 612 by the symbol “&”) with the value 128 (having binary expression of 10000000), and then bitwise shifting the result of that computation to the right by seven bits (represented in the program instruction 612 by the symbol “>>”). The symbol ⊙ refers to elementwise multiplication, and the symbol @ represents standard matrix multiplication. v_{odd} refers to the odd elements of the input embedding (not shown), and vₑᵥₑₙ refers to the even elements of the input embedding. Other implementations can achieve the same result using a different series of operations. Altogether, the program instruction is:

$$( {S}_{offset} , M ) @ v = ( ( 1 - ( ( {S}_{offset} \& 128 ) ≫ 7 ) ) ⊙ {S}_{offset} ) @ {v}_{odd} + ( ( ( {S}_{offset} \& 1 \; 28 ) ≫ 7 ) ⊙ ( {S}_{offset} - 128 ) ) © {v}_{e v e n}$$

As another variation, note that sparsification strategy used by the processing environment 102 can be combined with other compression strategies, such as quantization, to further reduce the size of the selected set of weights 116. Quantization involves reducing the size of each entry in the selected set of weights 116, e.g., by converting a floating point entry to a smaller-sized floating point entry or to a smaller-sized integer entry. Different systems in the processing environment 102 can perform quantization, including the training system 106 and/or the sparsification system 114. Background information on the general operation of quantization can be found in Xu, et al., “A Survey on Model Compression and Acceleration for Pretrained Language Models,” in arXiv archive, Cornell University, arXiv:2202.07105v2 [cs.CL], November 2022, 10 pages.

FIG. 7 shows an illustrative language model 702, which is one type of model to which the processing environment of FIG. 1 can be applied. The language model 702 is composed, in part, of a pipeline of transformer components, including a first transformer component 704. FIG. 7 provides details regarding one way to implement the first transformer component 704. Although not specifically illustrated, other transformer components of the language model 702 have the same architecture and perform the same functions as the first transformer component 704 (but are governed by separate sets of weights).

The language model 702 commences its operation with the receipt of input information, such as a passage of text. The prompt includes a series of linguistic tokens. In some examples, a “token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word. The principles set forth herein, however, are not limited to the processing of text information: in other examples, the language model 702 operates on any of: audio information, image information, video information, sensor information, and so on, or any combination thereof.

Next, an embedding component (not shown) maps the sequence of tokens into respective token embeddings. For example, the embedding component can produce one-hot vectors that describe the tokens, and can then map the one-hot vectors into the token embeddings using a machine-trained linear transformation. The embedding component then adds position information (and, in some cases, segment information) to the respective token embeddings to produce position-supplemented embedding vectors 706. The position information added to each token embedding describes the embedding vector's position in the sequence of token embeddings.

The first transformer component 704 operates on the position-supplemented embedding vectors 706. In some implementations, the first transformer component 704 includes, in order, an attention component 708, a first add-and-normalize component 710, a feed-forward neural network (FFN) component 712, and a second add-and-normalize component 714.

The attention component 708 determines how much emphasis should be placed on parts of input information when interpreting other parts of the input information. Consider, for example, a sentence that reads: “I asked the professor a question, but he could not answer it.” When interpreting the word “it,” the attention component 708 will determine how much weight or emphasis should be placed on each of the words of the sentence. The attention component 708 will find that that the word “question” is most significant.

The attention component 708 performs attention analysis using the following equation:

$$Attention ( Q , K , V ) = softmax ( \frac{Q {K}^{T}}{\sqrt{{d}_{k}}} ) V . \qquad ( 2 )$$

The attention component 708 produces query information Q by multiplying the position-supplemented embedding vectors 706 by a query weighting matrix W^{Q}. Similarly, the attention component 708 produces key information K and value information V by multiplying the position-supplemented embedding vectors 706 by a key weighting matrix W^{K} and a value weighting matrix W^{V}, respectively. To execute Equation (2), the attention component 708 takes the dot product of Q with the transpose of K, and then divides the dot product by a scaling factor \sqrt{d}, to produce a scaled result The symbol d represents the dimensionality of Q and K. The attention component 708 takes the Softmax (normalized exponential function) of the scaled result, and then multiplies the result of the Softmax operation by V, to produce attention output information. More generally stated, the attention component 708 determines how much emphasis should be placed on each part of input embedding information when interpreting other parts of the input embedding information, and when interpreting the same part. In some cases, the attention component 708 is said to perform masked attention insofar as the attention component 708 masks output token information that, at any given time, has not yet been determined. (Note that this type of making is unrelated to the mask-related functions described above). Background information regarding the general concept of attention is provided in Vaswani, et al., “Attention Is All You Need,” in 31st Conference on Neural Information Processing Systems (NIPS 2017), 2017, 9 pages.

Note that FIG. 7 shows that the attention component 708 is composed of plural attention heads, including a representative attention head 716. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 708 concatenates the output results of the attention component's separate attention heads, and then multiplies the results of this concatenation by another weight matrix W°.

The add-and-normalize component 710 includes a residual connection that combines (e.g., sums) input information fed to the attention component 708 with the output information generated by the attention component 708. The add-and-normalize component 710 then normalizes the output information generated by the residual connection, e.g., by layer-normalizing values in the output information based on the mean and standard deviation of those values, or by performing root-mean-squared normalization. The other add-and-normalize component 714 performs the same functions as the first-mentioned add-and-normalize component 710. The FFN component 712 transforms input information to output information using a feed-forward neural network having any number of layers.

The first transformer component 704 produces output embedding information 718. A series of other transformer components (720, . . . , 722) perform the same functions as the first transformer component 704, each operating on output embedding information produced by its immediately preceding transformer component. Each transformer component uses its own level-specific set of machine-trained weights. The final transformer component 722 in the language model 702 produces final output embedding information 724.

In some implementations, a post-processing component 726 performs post-processing operations on the final output embedding information 724. For example, the post-processing component 726 performs a machine-trained linear transformation on the final output embedding information 724, and processes the results of this transformation using a Softmax component (not shown). The language model 702 uses the output of the post-processing component 726 to predict the next token in the input sequence of tokens. In some applications, the language model 702 performs this task using a greedy selection approach (e.g., by selecting the token having the highest probability), or by using the beam search algorithm (e.g., by traversing a tree that expresses a search space of candidate next tokens). In other implementations, the post-processing component 726 represents a classification component, e.g., implemented using a fully-connected feed-forward neural network having one or more layers.

In some implementations, the language model 702 operates in an auto-regressive manner, as indicated by the loop 728. To operate in this way, the language model 702 appends a predicted token to the end of the sequence of input tokens, to provide an updated sequence of tokens. The predicted token leads to the production of a new position-supplemented vector 730. In a next pass, the language model 702 processes the updated sequence of position-supplemented vectors to generate a next predicted token. The language model 702 repeats the above process until it generates a specified stop token.

The above-described implementation of the language model 702 relies on a decoder-only architecture. Other implementations of the language model 702 use an encoder-decoder transformer-based architecture. Here, a transformer-based decoder receives encoder output information produced by a transformer-based encoder, together with decoder input information.

FIG. 7 shows an example in which the attention component 708 uses a first selected set of weights and mask, and the FNN component 712 uses a second selected set of weights and a mask. Other implementations similarly use their own layer-specific selected sets of weights and masks. To accommodate this implementation, the sparsification system 114 produces layer-specific selected sets of weights and masks. In other implementations, the processing environment 102 produces a different selected set of weights and mask for each transformer block of the language model 702, instead of the more fine-grained selected sets of weights and masks shown in FIG. 7.

Other implementations of the language model 702 use other kinds of machine-trained models besides, or in addition to, the particular transformer-based architecture shown in FIG. 7 The other machine-trained models include any of CNNs, RNNs, fully-connected feed-forward neural networks (FFNS), stable diffusion models, etc., or any combination thereof. In yet other implementations, a machine-trained model operates on data items other than language items, or in addition to language items. For example, another model removes noise from an input image (e.g., by performing super-resolution), classifies objects in an input image, extracts objects from an input image, and so on. In other words, the sparsification strategy used by the processing environment 102 is agnostic to the architecture of a model, the functions it performs, and the applications to which it is applied.

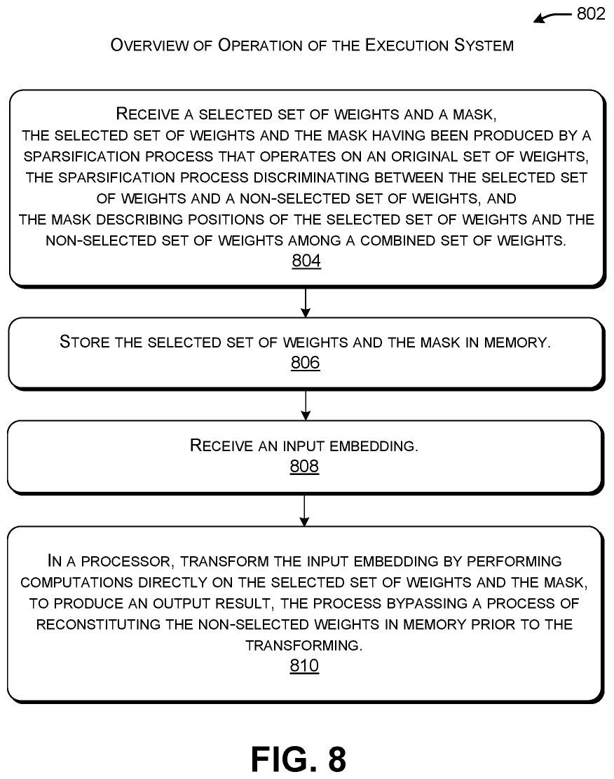

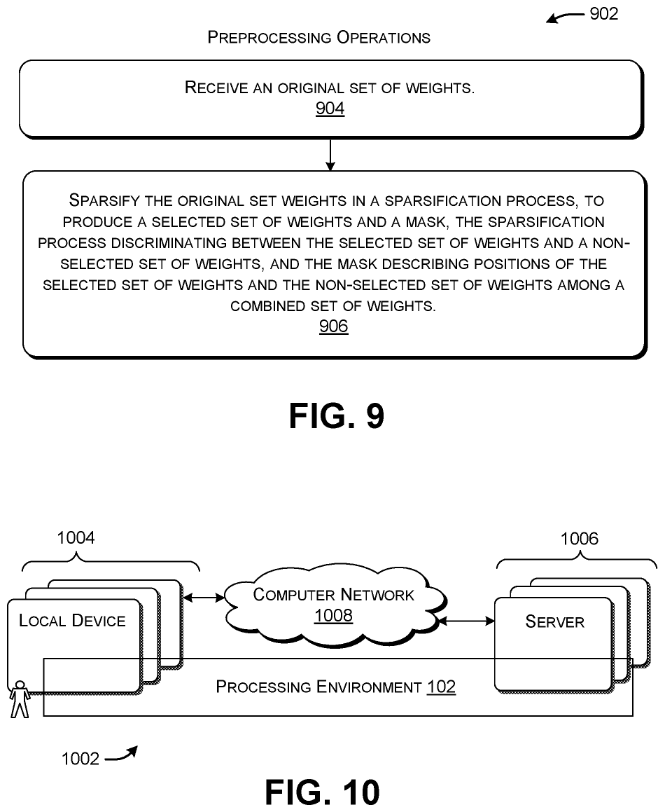

FIGS. 8 and 9 show two processes that represent an overview of the operation of the processing environment 102 of FIG. 1. Each of the processes is expressed as a series of operations performed in a particular order. But the order of these operations is merely representative, and the operations are capable of being varied in other implementations. Further, any two or more operations described below can be performed in a parallel manner. In one implementation, the blocks shown in the processes that pertain to processing-related functions are implemented by the computing equipment described in connection with FIGS. 10 and 11.

More specifically, FIG. 8 shows a process 802 for executing a machine-trained model. In block 804, the processing environment 102 receives a selected set of weights (e.g., the selected set of weights 116) and a mask (e.g., the mask 118). The selected set of weights and the mask are produced by a sparsification process that operates on an original set of weights (e.g., the original set of weights 108). The sparsification process discriminates between the selected set of weights and a non-selected set of weights (e.g., the non-selected set of weights 120). The mask describes positions of the selected set of weights and the non-selected set of weights among a combined set of weights (e.g., the combined set of weights 122). In block 806, the processing environment 102 stores the selected set of weights and the mask in memory (e.g., the memory 128). In block 808, the processing environment 102 receives an input embedding. In block 810, in a processor (e.g., the processing unit 402), the processing environment 102 transforms the input embedding by performing computations directly on the selected set of weights and the mask, to produce an output result. The process 802 bypasses (that is, omits) a process of reconstituting the non-selected weights in memory prior to the transforming.

FIG. 9 shows a process 902 for performing preliminary processing, which precedes the operations of the process 802. In block 904, the processing environment 102 receives an original set of weights (e.g., the original set of weights 116). In block 906, the processing environment 102 sparsifies the original set weights in a sparsification process, to produce a selected set of weights (e.g., the selected set of weights 116) and a mask (e.g., the mask 118). The sparsification process discriminates between the selected set of weights and a non-selected set of weights (e.g., the non-selected set of weights 120). The mask describes positions of the selected set of weights and the non-selected set of weights among a combined set of weights (e.g., the combined set of weights 122).

FIG. 10 shows computing equipment 1002 that, in some implementations, is used to implement the functionality of the processing environment 102. The computing equipment 1002 includes a set of local devices 1004 coupled to a set of servers 1006 via a computer network 1008. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1008 is implemented as a local area network, a wide area network (e.g., the Internet), one or more point-to-point links, or any combination thereof.

The bottom-most overlapping box in FIG. 10 indicates that the functionality of the processing environment 102 is capable of being spread across the local devices 1004 and/or the servers 1006 in any manner. In some implementations, each system of the processing environment 102 (e.g., any of the training system 106, the sparsification system 114, and the execution system 126) is entirely implemented by a local device or the servers 1006. For example, one implementation relies on a server-side implementation of the sparsification system 114, and a local implementation of the execution system 126, or vice versa. Another examples uses a server-side implementation of both the sparsification system 114 and the execution system 126, and so on. In other implementations, each system of the processing environment 102 can be implemented by processing functionality that is distributed over a local device and the servers 1006. Further note that one or more entities can develop and administer the separate systems of the processing environment 102.

FIG. 11 shows a computing system 1102 that, in some implementations, is used to implement any aspect of the mechanisms set forth in the above-described figures. For instance, in some implementations, the type of computing system 1102 shown in FIG. 11 is used to implement any local computing device or any server shown in FIG. 10. In all cases, the computing system 1102 represents a physical and tangible processing mechanism.

The computing system 1102 includes a processing system 1104 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1102 also includes computer-readable storage media 1106, corresponding to one or more computer-readable media hardware units. The computer-readable storage media 1106 retains any kind of information 1108, such as machine-readable instructions, settings, model weights, and/or other data. In some implementations, the computer-readable storage media 1106 includes one or more solid-state devices, one or more magnetic hard disks, one or more optical disks, magnetic tape, etc. Any instance of the computer-readable storage media 1106 uses any technology for storing and retrieving information. Further, any instance of the computer-readable storage media 1106 represents a fixed or removable unit of the computing system 1102. Further, any instance of the computer-readable storage media 1106 provides volatile and/or non-volatile retention of information.

More generally, any of the storage resources described herein, or any combination of the storage resources, is to be regarded as a computer-readable medium. In many cases, a computer-readable medium represents some form of physical and tangible entity. The term computer-readable medium also encompasses propagated signals, e.g., transmitted or received via a physical conduit and/or air or other wireless medium. However, the specific term “computer-readable storage medium” or “storage device” expressly excludes propagated signals per se in transit, while including all other forms of computer-readable media: a computer-readable storage medium or storage device is “non-transitory” in this regard.

The computing system 1102 utilizes any instance of the computer-readable storage media 1106 in different ways. For example, in some implementations, any instance of the computer-readable storage media 1106 represents a hardware memory unit (such as random access memory (RAM)) for storing information during execution of a program by the computing system 1102, and/or a hardware storage unit (such as a hard disk) for retaining/archiving information on a more permanent basis. In the latter case, the computing system 1102 also includes one or more drive mechanisms 1110 (such as a hard drive mechanism) for storing and retrieving information from an instance of the computer-readable storage media 1106.

In some implementations, the computing system 1102 performs any of the functions described above when the processing system 1104 executes computer-readable instructions stored in any instance of the computer-readable storage media 1106. For instance, in some implementations, the computing system 1102 carries out computer-readable instructions to perform each block of the processes described with reference to FIGS. 8 and 9. FIG. 11 generally indicates that hardware logic circuitry 1112 includes any combination of the processing system 1104 and the computer-readable storage media 1106. The hardware logic circuitry 1112 is also to be understood as one particular implementation of the processing unit 402 of FIG. 4.

In addition, or alternatively, the processing system 1104 includes one or more other configurable logic units that perform operations using a collection of logic gates. For instance, in some implementations, the processing system 1104 includes a fixed configuration of hardware logic gates, e.g., that are created and set at the time of manufacture, and thereafter unalterable. In addition, or alternatively, the processing system 1104 includes a collection of programmable hardware logic gates that are set to perform different application-specific tasks. The latter category of devices includes programmable array logic devices (PALs), generic array logic devices (GALs), complex programmable logic devices (CPLDs), field-programmable gate arrays (FPGAs), etc. In these implementations, the processing system 1104 effectively incorporates a storage device that stores computer-readable instructions, insofar as the configurable logic units are configured to execute the instructions and therefore embody or store these instructions.

In some cases (e.g., in the case in which the computing system 1102 represents a user computing device), the computing system 1102 also includes an input/output interface 1114 for receiving various inputs (via input devices 1116), and for providing various outputs (via output devices 1118). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1120 and an associated graphical user interface presentation (GUI) 1122. The display device 1120 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1102 also includes one or more network interfaces 1124 for exchanging data with other devices via one or more communication conduits 1126. One or more communication buses 1128 communicatively couple the above-described units together.

The communication conduit(s) 1126 is implemented in any manner, e.g., by a local area computer network, a wide area computer network (e.g., the Internet), point-to-point connections, or any combination thereof. The communication conduit(s) 1126 include any combination of hardwired links, wireless links, routers, gateway functionality, name servers, etc., governed by any protocol or combination of protocols.

FIG. 11 shows the computing system 1102 as being composed of a discrete collection of separate units. In some cases, the collection of units corresponds to discrete hardware units provided in a computing device chassis having any form factor. FIG. 11 shows illustrative form factors in its bottom portion. In other cases, the computing system 1102 includes a hardware logic unit that integrates the functions of two or more of the units shown in FIG. 11. For instance, in some implementations, the computing system 1102 includes a system on a chip (SoC or SOC), corresponding to an integrated circuit that combines the functions of two or more of the units shown in FIG. 11.

The following summary provides a set of illustrative examples of the technology set forth herein.

(A1) According to one aspect, a method (e.g., the process 802) is described for executing a machine-trained model (e.g., the transformer-based model 702). The method includes receiving (e.g., in block 804) a selected set of weights (e.g., the selected weights 116) and a mask (e.g., the mask 118). The selected set of weights and the mask have been produced by a sparsification process that operates on an original set of weights (e.g., the original set of weights 108), the sparsification process discriminating between the selected set of weights and a non-selected set of weights (e.g., the non-selected weights 120). The mask describes positions of the selected set of weights and the non-selected set of weights among a combined set of weights (e.g., the combined set of weights 122). The method further includes: storing (e.g., in block 806) the selected set of weights and the mask in memory (e.g., in the memory 128); receiving (e.g., in block 808) an input embedding; and in a processor (e.g., the transformation component 130), transforming (e.g., in block 810) the input embedding by performing computations directly on the selected set of weights and the mask, to produce an output result. The transforming computationally duplicates an effect of operating on the combined set of weights without a process of reconstituting the non-selected weights in memory prior to the transforming.

(A2) According to some implementations of the method of A1, the non-selected set of weights are weights that represent zero values.

(A3) According to some implementations of the method of A1 or A2, the sparsification process identifies the combined set of weights by setting a prescribed number of original weights in the original set of weights to the non-selected set of weights, based on a prescribed pattern.

(A4) According to some implementations of the method of A3, the prescribed pattern specifies, for a particular group of weights, a number of selected weights to be included in the particular group. A particular mask value in the mask specifies a location of a particular selected weight in the particular group of weights.

(A5) According to some implementations of any of the methods A1-A4, a particular mask value in the mask identifies whether a particular pair of weights in the combined set of weights includes a selected weight as a first member or a second member of the particular pair.

(A6) According to some implementations of any of the methods A1-A5, the mask has plural mask values, each mask value being represented by a single bit in the mask.

(A7) According to some implementations of any of the methods A1-A6, the transforming uses a particular mask value of the mask to evaluate plural ways of applying a particular weight of the selected set of weights to the input embedding, all but one of which will resolve to zero.

(A8) According to some implementations of any of the methods A1-A7, the transforming includes: multiplying a particular mask value by a particular weight of the selected set of weights and a particular element of the input embedding, to produce a first intermediate value; multiplying a binary opposite of the particular mask value by the particular weight and another particular element of the input embedding, to produce a second intermediate value; and adding the first intermediate value to the second intermediate value.

(A9) According to some implementations of any of the methods A1-A8, the mask has mask values that are separate from the selected set of weights.

(A10) According to some implementations of any of the methods A1-A9, the mask has mask values that are incorporated into weights in the selected set of weights.

(A11) According to some implementations of the method of A10, the method incorporates a particular mask value into a particular weight of the selected set of weights by adding an offset to the particular weight that reflects the particular mask value.

(A12) According to some implementations of the method of A11, the transforming computationally extracts the particular mask value from the particular weight.

(A13) According to some implementations of any of the methods A1-A12, the machine-trained model has plural layers, and wherein the method is performed for transformations executed by each layer of the plural layers.

(A14) According to some implementations of any of the methods A1-A13, the machine-trained model is a transformer-based model.

(A15) According to some implementations of any of the methods A1-A14, the processor is a graphics processing unit or a neural processing unit.

In yet another aspect, some implementations of the technology described herein include a computing system (e.g., the computing system 1102) that includes a processing system (e.g., the processing system 114) having a processor. The computing system also includes a storage device (e.g., the computer-readable storage media 1106) for storing computer-readable instructions (e.g., information 1108). The processing system executes the computer-readable instructions to perform any of the methods described herein (e.g., any individual method of the methods of A1-A15).

In yet another aspect, some implementations of the technology described herein include a computer-readable storage medium (e.g., the computer-readable storage media 1106) for storing computer-readable instructions (e.g., the information 1108). A processing system (e.g., the processing system 1104) executes the computer-readable instructions to perform any of the operations described herein (e.g., the operations in any individual method of the methods of A1-A15).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

As to terminology used in this description, the phrase “configured to” encompasses various physical and tangible mechanisms for performing an identified operation. The mechanisms are configurable to perform an operation using the hardware logic circuitry 1112 of FIG. 11. The term “logic” likewise encompasses various physical and tangible mechanisms for performing a task. For instance, each processing-related operation illustrated in the flowcharts of FIGS. 8 and 9 corresponds to a logic component for performing that operation.

This description may have identified one or more features as optional. This type of statement is not to be interpreted as an exhaustive indication of features that are to be considered optional: generally, any feature is to be considered as an example, although not explicitly identified in the text, unless otherwise noted. Further, any mention of a single entity is not intended to preclude the use of plural such entities: similarly, a description of plural entities in the specification is not intended to preclude the use of a single entity. As such, a statement that an apparatus or method has a feature X does not preclude the possibility that it has additional features. Further, any features described as alternative ways of carrying out identified functions or implementing identified mechanisms are also combinable together in any combination, unless otherwise noted.

In terms of specific terminology, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items: reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for executing a machine-trained model, comprising:
receiving a selected set of weights and a mask,
the selected set of weights and the mask having been produced by a sparsification process that operates on an original set of weights, the sparsification process discriminating between the selected set of weights and a non-selected set of weights, and
the mask describing positions of the selected set of weights and the non-selected set of weights among a combined set of weights;
storing the selected set of weights and the mask in memory;
receiving an input embedding; and
in a processor, transforming the input embedding by performing computations directly on the selected set of weights and the mask, to produce an output result.

2. The method of claim 1, wherein the non-selected set of weights are weights that represent zero values.

3. The method of claim 1, wherein the sparsification process identifies the combined set of weights by setting a prescribed number of original weights in the original set of weights to the non-selected set of weights, based on a prescribed pattern.

4. The method of claim 3,
wherein the prescribed pattern specifies, for a particular group of weights, a number of selected weights to be included in the particular group, and
wherein a particular mask value in the mask specifies a location of a particular selected weight in the particular group of weights.

5. The method of claim 1, wherein a particular mask value in the mask identifies whether a particular pair of weights in the combined set of weights includes a selected weight as a first member or a second member of the particular pair.

6. The method of claim 1, wherein the mask has plural mask values, each mask value being represented by a single bit in the mask.

7. The method of claim 1, wherein the transforming uses a particular mask value of the mask to evaluate plural ways of applying a particular weight of the selected set of weights to the input embedding, all but one of which will resolve to zero.

8. The method of claim 1, wherein the transforming comprises:
multiplying a particular mask value by a particular weight of the selected set of weights and a particular element of the input embedding, to produce a first intermediate value;
multiplying a binary opposite of the particular mask value by the particular weight and another particular element of the input embedding, to produce a second intermediate value; and
adding the first intermediate value to the second intermediate value.

9. The method of claim 1, wherein the mask has mask values that are separate from the selected set of weights.

10. The method of claim 1, wherein the mask has mask values that are incorporated into weights in the selected set of weights.

11. The method of claim 10, wherein the method incorporates a particular mask value into a particular weight of the selected set of weights by adding an offset to the particular weight that reflects the particular mask value.

12. The method of claim 11, wherein the transforming computationally extracts the particular mask value from the particular weight.

13. The method of claim 1, wherein the machine-trained model has plural layers, and wherein the method is performed for transformations executed by each layer of the plural layers.

14. The method of claim 1, wherein the machine-trained model is a transformer-based model.

15. The method of claim 1, wherein the processor is a graphics processing unit or a neural processing unit.

16. A computer-readable storage medium for storing computer-readable instructions, a processing system executing the computer-readable instructions to perform operations, the operations comprising:
receiving an original set of weights;
sparsifying the original set weights in a sparsification process, to produce a selected set of weights and a mask,
the sparsification process discriminating between the selected set of weights and a non-selected set of weights, and the mask describing positions of the selected set of weights and the non-selected set of weights among a combined set of weights;
storing the selected set of weights and the mask in memory;
receiving an input embedding; and
transforming the input embedding by performing computations directly on the selected set of weights and the mask, to produce an output result,
the transforming computationally duplicating an effect of operating on the combined set of weights without a process of reconstituting the non-selected set of weights in memory prior to the transforming.

17. The computer-readable storage medium of claim 16, wherein the transforming uses a particular mask value of the mask to evaluate plural ways of applying a particular weight of the selected set of weights to the input embedding, all but one of which will resolve to zero.

18. A computing system for determining whether a target item is supported by a source item, comprising:
a memory;
a processing system for executing computer-readable instructions, to perform operations including:
receiving a selected set of weights and a mask,
the selected set of weights and the mask having been produced by a sparsification process that operates on an original set of weights, the sparsification process discriminating between the selected set of weights and a non-selected set of weights, and
the mask describing positions of the selected set of weights and the non-selected set of weights among a combined set of weights;
storing the selected set of weights and the mask in the memory;
receiving an input embedding; and
transforming the input embedding by performing computations directly on the selected set of weights and the mask, to produce an output result,
the transforming using a particular mask value of the mask to evaluate plural ways of applying a particular weight of the selected set of weights to the input embedding, all but one of which will resolve to zero.

19. The computing system of claim 18,
wherein the sparsification process identifies the combined set of weights by setting a prescribed number of number of weights in the original set of weights to the non-selected set of weights, based on a prescribed pattern,
wherein the prescribed pattern specifies, for a particular group of weights of a plurality of groups of weights, a number of selected weights to be included in the particular group, and
wherein a particular mask value in the mask specifies a location of a particular selected weight in the particular group of weights.

20. The computing system of claim 19, wherein the prescribed number is 50 percent.
